(19) United States
(12) Patent Application Publication
(10) Pub. No.: US 2009/0040909 A1
(43) Pub. Date: Feb. 12, 2009

(54) Optical head device and optical information device

(76) Inventors: Joji Anzai, Osaka (JP); Hideki Aikoh, Osaka (JP); Akihiro Arai, Kyoto (JP); Hideki Nakata, Kyoto (JP); Fumitomo Yamasaki, Nara (JP); Yoshiaki Komma, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/918,780

(22) PCT Filed: Apr. 20, 2006
(86) PCT No.: PCT/JP2006/308292

§ 371 Date: Oct. 18, 2007

(30) Foreign Application Priority Data
Apr. 21, 2005 (JP) 2005-123215

(51) Int. Cl. G11B 7/135

(52) U.S. Cl. 369/112.24

(57) ABSTRACT

An optical head device is provided with a light source 1 for emitting a plurality of lights having different wavelengths, an objective lens 31 for focusing a light spot on an optical disc 21, an objective lens 32 for focusing light spots on optical discs 22 to 24, and a prism 53 for splitting a laser light having a wavelength of 405 nm from the light source 1 into a transmitting light and a reflected light, introducing the reflected light to the objective lens 31 and the transmitting light to the objective lens 32, and introducing laser lights having wavelengths of 660 nm, 780 nm from the light source 1 to the objective lens 32.

### TECHNICAL FIELD

The present invention relates to an optical head device used for the recording and/or reproduction of information in or from an optical recording medium such as an optical disc or an optical card, and an optical information device using such an optical head device.

### DESCRIPTION OF THE BACKGROUND ART

At present, optical discs include CDs and DVD, BDs (Blu-ray Discs) and HD-DVDs realizing higher-density recording using blue lasers. Accordingly, there is a demand for optical head devices with read/write compatibility of optical discs having difference specifications. As means meeting such a demand, there is an optical head device, for example, as disclosed in patent literature 1. This construction is such that two kinds of objective lens and optical systems, i.e. an objective lens and an optical system corresponding to DVDs and CDs and those corresponding to BDs and the like are mounted on one optical head device to enable the recording or reproduction of optical disc having three kinds of different specifications.

However, since the two kinds of objective lens corresponding to different optical discs and the optical systems independent of the objective lenses are necessary in this construction, the number of parts increases and it is difficult to miniaturize the device and to reduce costs.

Patent Literature 1: Japanese Unexamined Patent Publication No. H11-120587

### DISCLOSURE OF THE INVENTION

An object of the present invention is to provide an optical head device and an optical information device which can record or produce information in or from a plurality of information recording media having different specifications and can be miniaturized and reduce costs by decreasing the number of parts.

One aspect of the present invention is directed to an optical head device, comprising a light source for emitting a plurality of lights having different wavelengths; focusing means for focusing a light spot on an information recording medium with a track; and detecting means for detecting a light reflected from the information recording medium, wherein the focusing means includes a first objective lens for focusing a light spot on a first information recording medium, a second objective lens for focusing a light spot on a second information recording medium different from the first information recording medium, and optical axis changing means for splitting one of the plurality of lights from the light source into a transmitting light and a reflected light at a specified ratio, introducing the reflected light to the first objective lens and the transmitting light to the second objective lens, and introducing the remainder of the plurality of lights from the light source to either one of the first and second objective lenses.

Another aspect of the present invention is directed to an optical information device, comprising the above optical head device for recording and/or reproducing information in and/or from an information recording medium using the optical head device.

According to the above respective constructions, one of the plurality of lights from the light source is split into the transmitting light and the reflected light at the specified ratio, the reflected light is introduced to the first objective lens, the transmitting light is introduced to the second objective lens and the remainder is introduced to one of the first and second objective lenses. Thus, recording and reproduction can be made in and from a plurality of optical discs having different specifications, and miniaturization and lower costs can be realized by decreasing the number of parts.

### BRIEF DESCRIPTION OF THE DRAWINGS

FIG. 1 is a diagram showing the construction of an optical head device according to a first embodiment of the invention,

FIG. 2 is a diagram showing the construction of an optical head device according to a second embodiment of the invention,

FIG. 3 is a diagram showing the construction of an optical head device according to a third embodiment of the invention,

FIG. 4 is a diagram showing the construction of an optical head device according to a fourth embodiment of the invention,

FIG. 5 is a diagram showing the construction of an optical head device according to a fifth embodiment of the invention,

FIGS. 6A to 6C are diagrams showing retracting movements of mirrors shown in FIG. 5,

FIG. 7 is a diagram showing the construction of an optical head device according to a sixth embodiment of the invention, and

FIG. 8 is a diagram showing the construction of an optical head device according to a seventh embodiment of the invention.

### BEST MODES FOR EMBODYING THE INVENTION

Hereinafter, embodiments of the present invention are described with reference to the drawings.

### First Embodiment

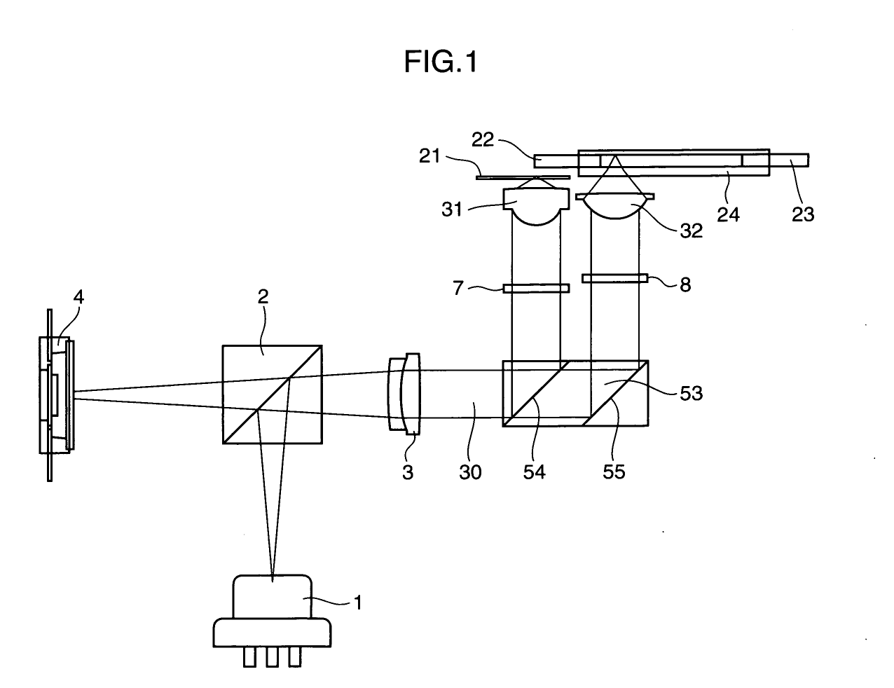

First, an optical head device according to a first embodiment of the present invention is described with reference to FIG. 1. FIG. 1 is a construction diagram of the optical head device according to the first embodiment of the present invention.

The optical head device shown in FIG. 1 is provided with a light source 1, a polarizing beam splitter 2, a collimator lens 3, a photodetector 4, wavelength plates 7, 8, objective lenses 31, 32 and a prism 53. An optical disc 21 is a BD whose protection layer has a thickness of about 0.1 mm; an optical disc 22 is an HD-DVD whose protection layer has a thickness of about 0.6 mm; an optical disc 23 is a DVD whose protection layer has a thickness of about 0.6 mm; and an optical disc 24 is a CD whose protection layer has a thickness of about 1.2 mm. The respective optical discs 21 to 24 are information recording media with tracks in or from which information is recorded or reproduced.

The light source 1 includes a semiconductor laser and the like and emits laser lights having three wavelengths (405 nm, 660 nm and 780 nm). The polarizing beam splitter 2 introduces a laser light from the light source 1 to the collimator lens 3 by reflecting it. The collimator lens 3 collimates the laser light from the polarizing beam splitter 2 and introduces a light beam 30 to the prism 53. Further, the polarizing beam splitter 2 transmits a reflected light from the collimator lens 3 and introduces it to the photodetector 4.

The prism 53 is an example of optical axis changing means and has first and second surfaces 54, 55. The first surface 54 has an optical film for introducing a part of the light having a wavelength of 405 nm to the second surface 55 by transmitting it, introducing the remaining part to the wavelength plate 7 by reflecting it, and introducing lights having wavelengths of 660 nm and 780 nm to the second surface 55 by fully reflecting them. The second surface 55 has a reflection film for introducing three lights having wavelengths of 405 nm, 660 nm and 780 nm to the wavelength plate 8 by fully reflecting them. The prism 53 causes a light having a wavelength of 405 nm to be incident on the object lens 31 and lights having wavelengths of 405 nm, 660 nm and 780 nm to be incident on the objective lens 32, thereby making recording or reproduction in or from four types of optical discs 21 to 24 compatible.

The wavelength plates 7, 8 are ¼-λ plates. The objective lens 31 is an objective lens with an NA of 0.85 corresponding to BDs, and the objective lens 32 is an objective lens with an NA of 0.65 corresponding to HD-DVDs, DVDs and CDs. It should be noted that the number of objective lenses is not particularly limited to the above example, and three or more objective lenses may be used. In this case, a surface for reflecting and transmitting a beam at specified ratios according to the wavelength like the first surface 54 is added.

Here, if f1 and f2 denote the focal lengths of the objective lenses 31, 32, the focal length f2 of the objective lens 32 preferably satisfies an equation: f2≈(f1×0.85)/0.65. In this case, the diameter of a beam reflected by the BD optical disc 21 and having transmitted through the objective lens 31 becomes substantially equal to that of a beam reflected by the optical disc 22 of the HD-DVD and having transmitted through the objective lens 32, whereby the shape of a detection spot by the reflected light from the BD optical disc 21 and that of a detection light by the reflected light from the HD-DVD optical disc 22 becomes substantially equal on the photodetector 4. Therefore, the reflected light from the BD and that from the HD-DVD can be detected using one photodetector 4.

The NAs and focal lengths of the objective lenses 31, 32 are not particularly limited to the above example, and various changes can be made. For example, if the NA of the objective lens 31 is 0.85 or larger and that of the objective lens 32 is about 0.65, the focal length f2 of the objective lens 32 having a smaller NA may be longer than the focal length fl of the objective lens 31 having a larger NA. In this case, the focusing position of a light spot by the objective lens 31 and that of a light spot by the objective lens 32 differ in the thickness direction of the optical disc. Thus, adverse effects of the light from the objective lens 32 can be prevented when information is recorded or reproduced in or from the BD optical disc 21 using the objective lens 31, and adverse effects of the light from the objective lens 31 can be prevented when information is recorded or reproduced in or from the HD-DVD optical disc 22 using the objective lens 32.

Next, the recording and reproducing operations of the optical head device constructed as above are described. First, the case of performing the recording operation or reproducing operation for the BD optical disc 21 is described. A laser light having a wavelength of 405 nm is emitted from the light source 1 and reflected by the polarizing beam splitter 2. The laser light reflected by the polarizing beam splitter 2 transmits through the collimator lens 3 and is introduced as the light beam 30 to the first surface 54 of the prism 53. The first surface 54 reflects a part (e.g. 50%) of the laser light of 405 nm and introduces it to the objective lens 31 via the wavelength plate 7. The objective lens 31 focuses the laser light having a wavelength of 405 nm on a recording surface of the optical disc 21. The light reflected by the recording surface of the optical disc 21 transmits through the objective lens 31 and wavelength plate 7 again to be reflected by the first surface 54 of the prism 53. The light reflected by the first surface 54 transmits through the collimator lens 3 and polarizing beam splitter 2 to be incident on the photodetector 4, which detects the reflected light having a wavelength of 405 nm from the optical disc 21.

Next, the case of performing the recording operation or reproducing operation for the HD-DVD optical disc 22 is described. A laser light having a wavelength of 405 nm is emitted from the light source 1 and reflected by the polarizing beam splitter 2. The laser light reflected by the polarizing beam splitter 2 transmits through the collimator lens 3 and is introduced as the light beam 30 to the first surface 54 of the prism 53. The first surface 54 reflects a part (e.g. 50%) of the laser light of 405 nm, and introduces the remaining part (e.g. 50%) to the second surface 55 of the prism 53. The second surface 55 fully reflects the laser light having a wavelength of 405 nm and introduces it to the objective lens 32 via the wavelength plate 8. The objective lens 32 focuses the laser light having a wavelength of 405 nm on a recording surface of the optical disc 22. The light reflected by the recording surface of the optical disc 22 transmits through the objective lens 32 and wavelength plate 8 again to be fully reflected by the second surface 55 of the prism 53. The light fully reflected by the second surface 55 transmits through the first surface 54, collimator lens 3 and polarizing beam splitter 2 to be incident on the photodetector 4, which detects the reflected light having a wavelength of 405 nm from the optical disc 22.

As described, the light source 1 preferably emits the laser light having a wavelength of 405 nm with a rated output of 150 mW or higher in the case of recording information in the BD optical disc 21 and the HD-DVD optical disc 22. In this case, recording can be reliably made in the BD by the objective lens 31 and in the HD-DVD by the objective lens 32.

Next, the case of performing the recording operation or reproducing operation for the DVD optical disc 23 is described. A laser light having a wavelength of 660 nm is emitted from the light source 1 and reflected by the polarizing beam splitter 2. The laser light reflected by the polarizing beam splitter 2 transmits as the light beam 30 through the collimator lens 3 and the first surface 54 of the prism 53 and is introduced to the second surface 55 of the prism 53. The second surface 55 fully reflects the laser light having a wavelength of 660 nm and introduces it to the objective lens 32 via the wavelength plate 8. The objective lens 32 focuses the laser light having a wavelength of 660 nm on a recording surface of the optical disc 23. The light reflected by the recording surface of the optical disc 23 transmits through the objective lens 32 and wavelength plate 8 again to be fully reflected by the second surface 55 of the prism 53. The light fully reflected by the second surface 55 transmits through the first surface 54, collimator lens 3 and polarizing beam splitter 2 to be incident on the photodetector 4, which detects the reflected light having a wavelength of 660 nm.

Next, the case of performing the recording operation or reproducing operation for the CD optical disc 24 is described. A laser light having a wavelength of 780 nm is emitted from the light source 1 and reflected by the polarizing beam splitter 2. The laser light reflected by the polarizing beam splitter 2 transmits as the light beam 30 through the collimator lens 3 and the first surface 54 of the prism 53 and is introduced to the second surface 55 of the prism 53. The second surface 55 fully reflects the laser light having a wavelength of 780 nm and introduces it to the objective lens 32 via the wavelength plate 8. The objective lens 32 focuses the laser light having a wavelength of 780 nm on a recording surface of the optical disc 24. The light reflected by the recording surface of the optical disc 24 transmits through the objective lens 32 and wavelength plate 8 again to be fully reflected by the second surface 55 of the prism 53. The light fully reflected by the second surface 55 transmits through the first surface 54, collimator lens 3 and polarizing beam splitter 2 to be incident on the photodetector 4, which detects the reflected light having a wavelength of 780 nm.

By the above operation, the recording operation and reproducing operation can be performed for four types of optical discs 21 to 24 having different specifications in this embodiment. Thus, compatibility with four types of optical discs having different specifications is realized. Further, since the light source 1, polarizing beam splitter 2, collimator lens 3, photodetector 4 and prism 53 can be commonly used for four types of optical discs having different specifications, miniaturization and lower costs resulting from a decreased number of parts can be realized. Furthermore, since no movable member is used in this embodiment, the respective parts can be positioned with high accuracy and there is no unnecessary loss of light caused by displacements and the like of the respective parts.

Although the first surface 54 of the prism 53 reflects 50 t of the laser light having a wavelength of 405 nm and transmits the remaining 50% in the above example, the reflectance and transmittance of the first surface 54 of the prism 53 are not particularly limited to this example and various changes can be made. For example, in the case of performing only the reproducing operation for the HD-DVD optical disc 22, it is, for example, preferable that the first surface 54 of the prism 53 reflects 70% to 90% of the laser light having a wavelength of 405 nm and transmits the remaining 30% to 10% of the laser light having a wavelength of 405 nm and introduces it to the second surface 55 of the prism 53. In this case, the recording and reproduction of BDs can be made using the objective lens 31 and the reproduction of HD-DVDs and the recording and reproduction of DVDs and CDs can be made using the objective lens 32.

If the objective lens 31 is for HD-DVDs and the objective lens 32 is for BDs, it is, for example, preferable that the first surface 54 of the prism 53 reflects 10% to 30% of the laser light having a wavelength of 405 nm and transmits the remaining 90% to 70% of the laser light having a wavelength of 405 nm and introduces it to the second surface 55 of the prism 53. In this case as well, effects similar to the above can be obtained.

Without being particularly restricted to the above prism 53, the optical axis changing means used in this embodiment may be constructed as in a fifth embodiment to be described later such that a mirror closer to the light source 1 out of two mirrors used has the same film characteristic as the first surface 54 and splits a light having a wavelength of 405 nm by the reflection and transmission similar to the above. In this case as well, effects similar to the above can be obtained.

Although the objective lens 31 is for BDs and the objective lens 32 is for HD-DVDs, DVDs and CDs in the above description, various changes can be made without being particularly restricted to this example. For example, the objective lens 32 may be for BDs and the objective lens 31 may be for HD-DVDs, DVDs and CDs. In this case, the film characteristics of the first and second surfaces 54, 55 of the prism 53 are set such that the first surface 54 reflects and transmits the laser light having a wavelength of 405 nm and fully reflect the laser lights having wavelengths of 660 nm and 780 nm to introduce them to the objective lens 31 and that the second surface 55 fully reflects the laser light having a wavelength of 405 nm, and the NAs and focal lengths of the objective lenses 31, 32 suitable for the respective optical discs are set. The above points also hold for other embodiments to be described later.

### Second Embodiment

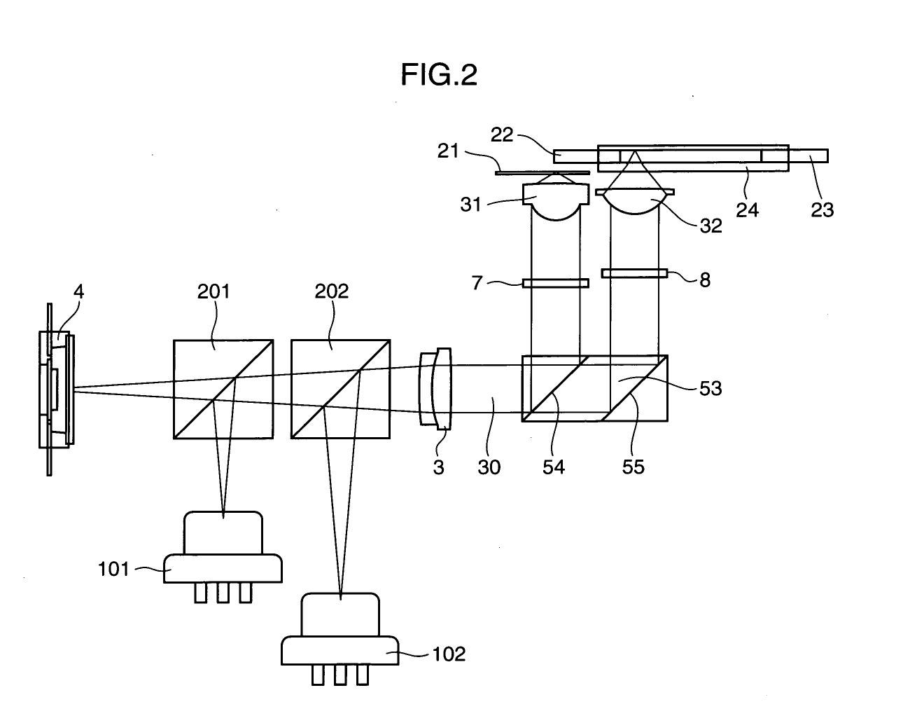

Next, an optical head device according to a second embodiment of the present invention is described with reference to FIG. 2. FIG. 2 is a construction diagram of the optical head device according to the second embodiment of the present invention. The optical head device shown in FIG. 2 differs from the one shown in FIG. 1 in that two light sources 101, 102 and two polarizing beam splitters 201, 202 are used instead of one light source 1 and one polarizing beam splitter 2. Since this optical head device is similar to the one shown in FIG. 1 in other points, the same parts are not described in detail by being identified by the same reference numerals.

The light source 101 emits a laser light having a wavelength of 405 nm, and the polarizing beam splitter 201 reflects the laser light from the light source 101 and introduces it to a collimator lens 3 via the polarizing beam splitter 202. The operation between the collimator lens 3 and each disc 21, 22 is as in the first embodiment. A reflected light from the BD optical disc 21 or from the HD-DVD optical disc 22 transmits through the collimator lens 3 and the polarizing beam splitters 202, 201 to be incident on a photodetector 4, which detects the reflected light having a wavelength of 405 nm.

The light source 102 emits laser lights having two wavelengths (660 nm, 780 nm) and the polarizing beam splitter 202 reflects the laser light from the light source 102 and introduces it to the collimator lens 3. The operation between the collimator lens 3 and each disc 23, 24 is as in the first embodiment. A reflected light from the DVD optical disc 23 or from the CD optical disc 24 transmits through the collimator lens 3 and polarizing beam splitters 202, 201 to be incident on the photodetector 4, which detects the reflected light having a wavelength of 660 nm or 780 nm.

By the above construction, in this embodiment, effects similar to those of the first embodiment can be obtained, and low-cost semiconductor lasers can be used as the light sources 101, 102 to enable further cost reduction.

### Third Embodiment

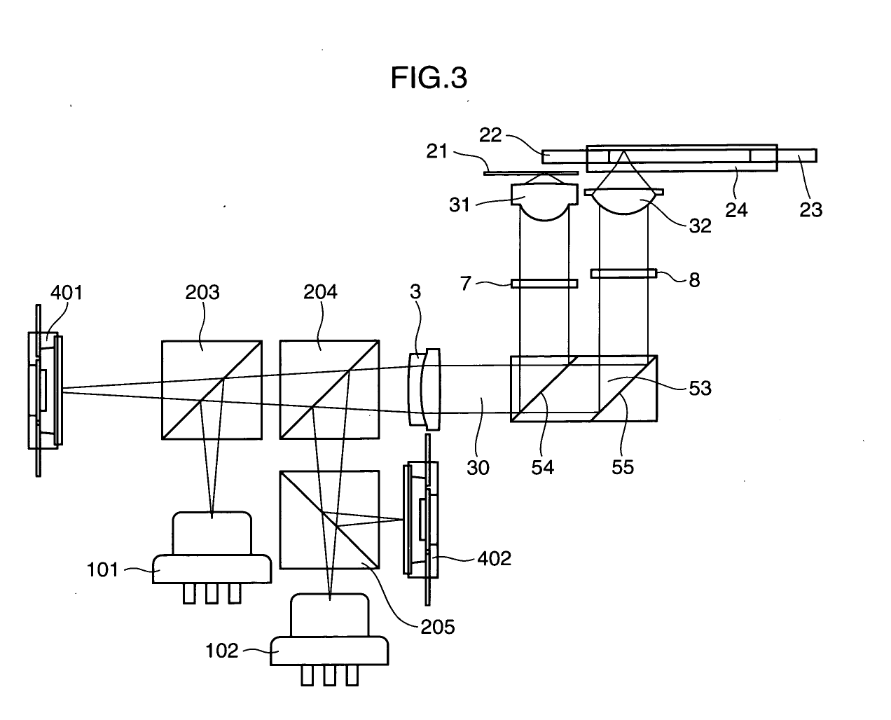

Next, an optical head device according to a third embodiment of the present invention is described with reference to FIG. 3. FIG. 3 is a construction diagram of the optical head device according to the third embodiment of the present invention. The optical head device shown in FIG. 3 differs from the one shown in FIG. 2 in that three polarizing beam splitters 203, 204 and 205 and two photodetectors 401, 402 are used instead of two polarizing beam splitters 201, 202 and one photodetector 4. Since this optical head device is similar to the one shown in FIG. 2 in other points, the same parts are not described in detail by being identified by the same reference numerals.

The polarizing beam splitter 203 reflects a laser light having a wavelength of 405 nm from a light source 101 and introduces it to a collimator lens 3 via the polarizing beam splitter 204. The operation between the collimator lens 3 and each disc 21, 22 is as in the first embodiment. A reflected light from the BD optical disc 21 or from the HD-DVD optical disc 22 transmits through the collimator lens 3 and polarizing beam splitters 204, 203 to be incident on the photodetector 401, which detects the reflected light having a wavelength of 405 nm.

The polarizing beam splitter 205 transmits a laser light having a wavelength (660 nm, 780 nm) from a light source 102 and introduces it to the polarizing beam splitter 204, and the polarizing beam splitter 204 reflects the light from the polarizing beam splitter 205 and introduces it to the collimator lens 3. The operation between the collimator lens 3 and each disc 23, 24 is as in the first embodiment. A reflected light from the DVD optical disc 23 or from the CD optical disc 24 is reflected by the polarizing beam splitter 204 to be incident on the polarizing beam splitter 205. The polarizing beam splitter 205 reflects the above reflected light to be incident on the photodetector 402, which detects the reflected light having a wavelength of 660 nm or 780 nm.

By the above construction, in this embodiment, effects similar to those of the second embodiment can be obtained, and low-cost photodetectors can be used as the photodetectors 401, 402 to enable further cost reduction.

### Fourth Embodiment

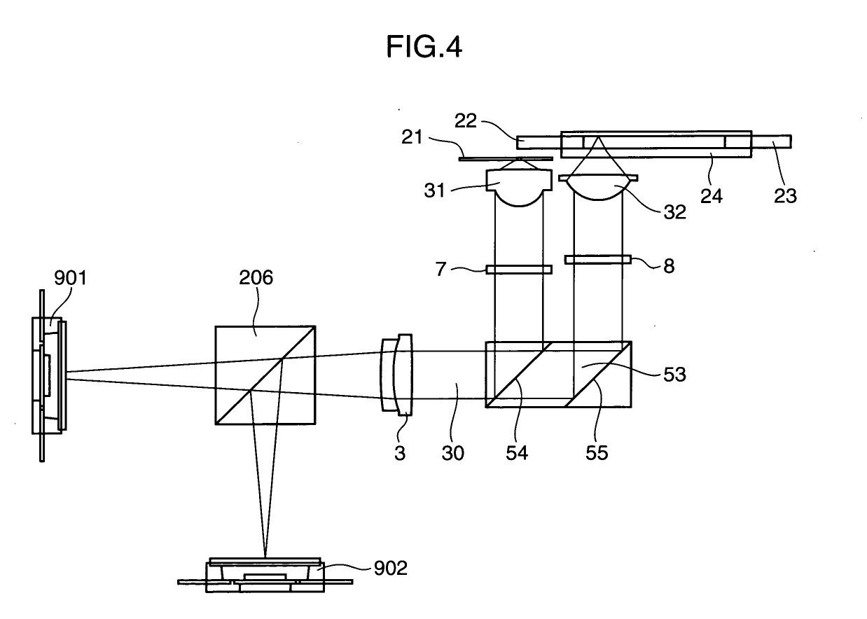

Next, an optical head device according to a fourth embodiment of the present invention is described with reference to FIG. 4. FIG. 4 is a construction diagram of the optical head device according to the fourth embodiment of the present invention. The optical head device shown in FIG. 4 differs from the one shown in FIG. 1 in that two units 901, 902, each being an integral unit of a light source and a photodetector, and a polarizing beam splitter 206 are used instead of the light source 1, photodetector 4 and polarizing beam splitter 2. Since this optical head device is similar to the one shown in FIG. 1 in other points, the same parts are not described in detail by being identified by the same reference numerals.

The unit 901 emits a laser light having a wavelength of 405 nm and the polarizing beam splitter 206 transmits the laser light from the unit 901 to introduce it to a collimator lens 3. The operation between the collimator lens 3 and each disc 21, 22 is as in the first embodiment. A reflected light from the BD optical disc 21 or from the HD-DVD optical disc 22 transmits through the collimator lens 3 and polarizing beam splitter 206 to be incident on the unit 901, which detects the reflected light having a wavelength of 405 nm.

The unit 902 transmits laser a light having a wavelength (660 nm, 780 nm) and the polarizing beam splitter 206 reflects the laser light from the unit 902 and introduces it to the collimator lens 3. The operation between the collimator lens 3 and each disc 23, 24 is as in the first embodiment. A reflected light from the DVD optical disc 23 or from the CD optical disc 24 is reflected by the polarizing beam splitter 206 to be incident on the unit 902, which detects the reflected light having a wavelength of 660 nm or 780 nm.

By the above construction, in this embodiment, effects similar to those of the first embodiment can be obtained. Since the unit 901 for emitting a laser light having a wavelength of 405 nm includes the photodetector for BDs and HD-DVDs, and the unit 902 for emitting laser lights having wavelengths of 660 nm and 780 nm includes the photodetector for DVDs and CDs, the light sources and photodetector suitable for the respective wavelengths can be unitized and the costs of the units 901, 902 can be reduced. It should be noted that the combination of the light source and photodetector in each unit is not particularly restricted to the above example and various changes can be made.

### Fifth Embodiment

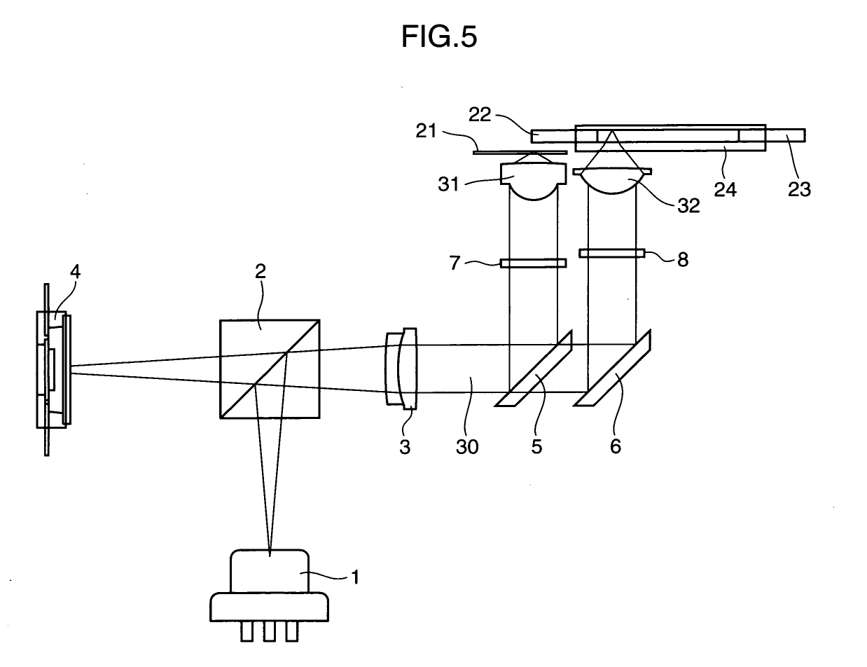

Next, an optical head device according to a fifth embodiment of the present invention is described with reference to FIG. 5. FIG. 5 is a construction diagram of the optical head device according to the fifth embodiment of the present invention.

In FIG. 5, identified by 21 is a BD whose protection layer has a thickness of about 0.1 mm; by 22 a HD-DVD whose protection layer has a thickness of about 0.6 mm; by 23 a DVD whose protection layer has a thickness of about 0.6 mm and by 24 a CD whose protection layer has a thickness of about 1.2 mm. Identified by 1 is a light source for emitting laser lights having three wavelengths (405 nm, 660 nm, 780 nm); by 2 a polarizing beam splitter; by 3 a collimator lens; by 5 and 6 mirrors as an example of optical axis changing means; by 7 and 8 wavelength plates which are ¼-λ plates; by 31 an objective lens corresponding to BDs and having an NA of 0.85; by 32 an objective lens corresponding to HD-DVDs, DVDs and CDs and having an NA of 0.65 and by 4 a photodetector.

First, the case of performing the recording operation or reproducing operation for the BD optical disc 21 is described. A laser light having a wavelength of 405 nm is emitted from the light source 1, is reflected by the polarizing beam splitter 2, transmits through the collimator lens 3 to be reflected by the mirror 5, and transmits through the wavelength plate 7 and objective lens 31 to be focused on a recording surface of the optical disc 21. The light reflected by the recording surface of the optical disc 21 transmits through the objective lens 31 and wavelength plate 7 again to be reflected by the mirror 5, and transmits through the collimator lens 3 and polarizing beam splitter 2 to be incident on the photodetector 4.

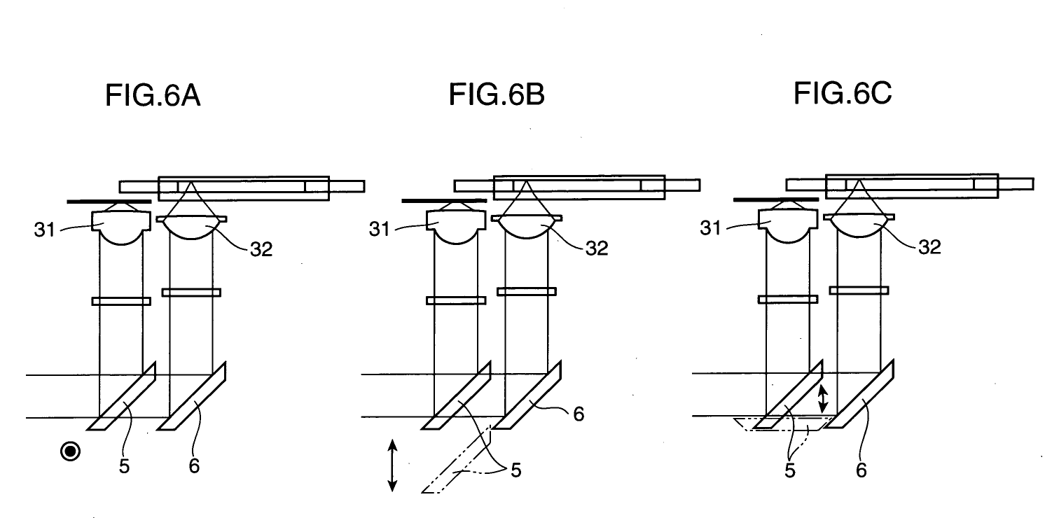

Next, the case of performing the recording operation or reproducing operation for the optical discs 22, 23 and 24 is described. FIGS. 6A to 6C are diagrams showing retracting movements of the mirror 5 shown in FIG. 5. In this case, in order to introduce the laser light from the light source 1 to the mirror 6, the mirror 5 moves away in a direction perpendicular to the plane of FIG. 6A using an unillustrated actuator or the like as shown in FIG. 6A or moves away downward as shown in FIG. 6B or inclines away as shown in FIG. 6C.

In the above state, the case of performing the recording operation or reproducing operation for the optical disc 22 is described. A laser light having a wavelength of 405 nm is emitted from the light source 1, is reflected by the polarizing beam splitter 2, transmits through the collimator lens 3 to be reflected by the mirror 6, and transmits through the wavelength plate 8 and objective lens 32 to be focused on a recording surface of the optical disc 22. The light reflected by the recording surface of the optical disc 22 transmits through the objective lens 32 and wavelength plate 8 again to be reflected by the mirror 6, and transmits through the collimator lens 3 and polarizing beam splitter 2 to be incident on the photodetector 4.

Next, the case of performing the recording operation or reproducing operation for the optical disc 23 is described. A laser light having a wavelength of 660 nm is emitted from the light source 1, is reflected by the polarizing beam splitter 2, transmits through the collimator lens 3 to be reflected by the mirror 6, and transmits through the wavelength plate 8 and objective lens 32 to be focused on a recording surface of the optical disc 23. The light reflected by the recording surface of the optical disc 23 transmits through the objective lens 32 and wavelength plate again to be reflected by the mirror 6, and transmits through the collimator lens 3 and polarizing beam splitter 2 to be incident on the photodetector 4.

Next, the case of performing the recording operation or reproducing operation for the optical disc 24 is described. A laser light having a wavelength of 780 nm is emitted from the light source 1, is reflected by the polarizing beam splitter 2, transmits through the collimator lens 3 to be reflected by the mirror 6, and transmits through the wavelength plate 8 and objective lens 32 to be focused on a recording surface of the optical disc 24. The light reflected by the recording surface of the optical disc 24 transmits through the objective lens 32 and wavelength plate 8 again to be reflected by the mirror 6, and transmits through the collimator lens 3 and polarizing beam splitter 2 to be incident on the photodetector 4.

As described above, the optical head device of this embodiment is compatible with four types of optical discs having different specifications. Although the objective lens 31 is for the optical disc 21 and the objective lens 32 is for the optical discs 22 to 23 in this embodiment, it goes without saying that effects similar to the above can be also obtained in a reverse case without being particularly restricted to this example. In such a case, the Mirror 5 is moved in conformity with the wavelengths corresponding to the respective optical discs.

### Sixth Embodiment

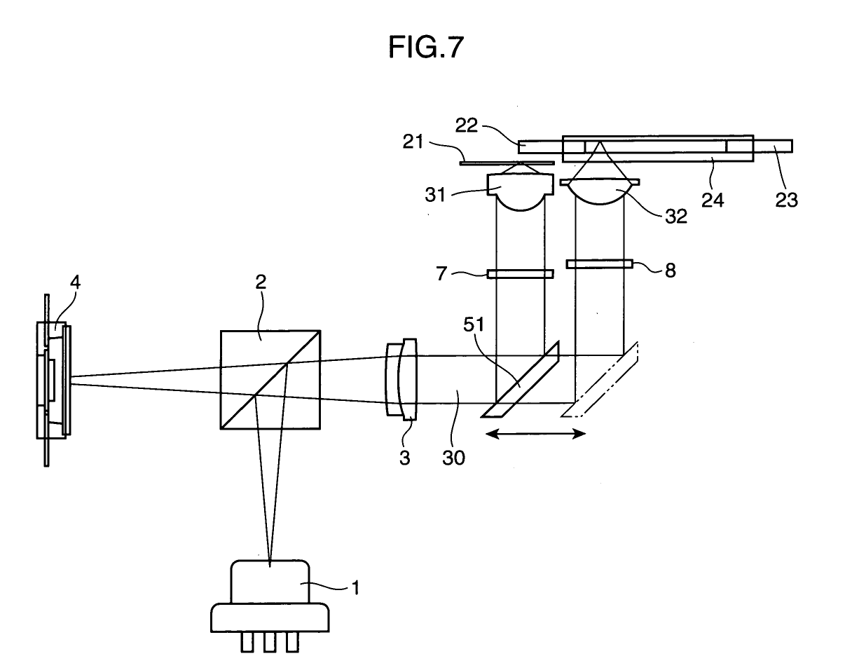

Next, an optical head device according to a sixth embodiment of the present invention is described with reference to FIG. 7. FIG. 7 is a construction diagram of the optical head device according to the sixth embodiment of the present invention. In the optical head device of the sixth embodiment shown in FIG. 7, the same elements as in the fifth embodiment are not described by being identified by the same reference numerals.

The optical head device of this embodiment differs from the one of the fifth embodiment in the following point. The incidence of a light beam 30 on objective lenses 31, 32 is switched using one mirror 51 unlike the fifth embodiment using the two mirrors 5, 6 as an example of the optical axis changing means. In this case, the mirror 51 is moved along an propagation direction of the light beam 30 having transmitted through a collimator lens 3 as shown in FIG. 7 using an unillustrated actuator or the like, thereby switching the incidence of the light beam 30 on the objective lens 31 or on the objective lens 32 to make the recording or reproduction of four types of optical discs compatible.

### Seventh Embodiment

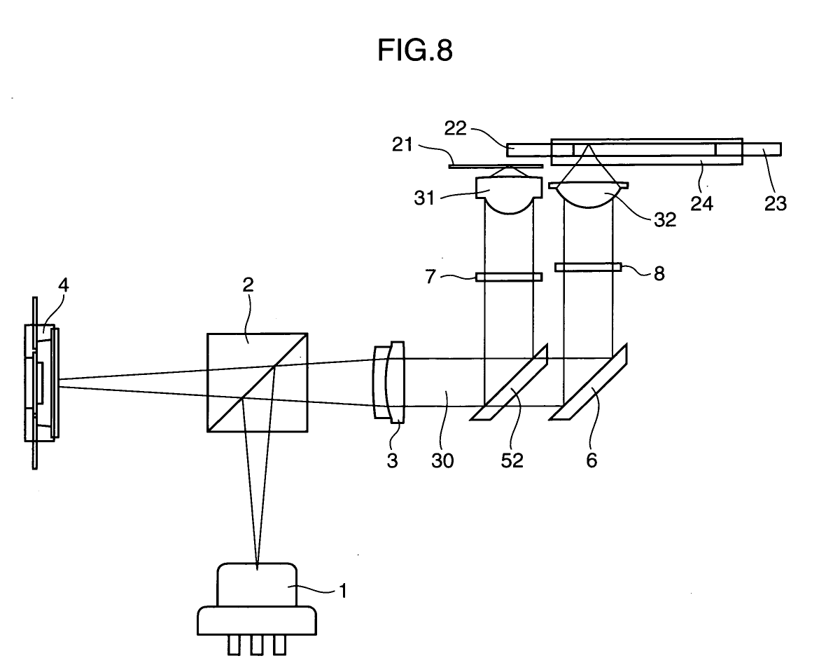

Next, an optical head device according to a seventh embodiment of the present invention is described with reference to FIG. 8. FIG. 8 is a construction diagram of the optical head device according to the seventh embodiment of the present invention. In the optical head device of the seventh embodiment shown in FIG. 8, the same elements as in the fifth embodiment are not described by being identified by the same reference numerals.

The optical head device of this embodiment differs from the one of the fifth embodiment in using a liquid crystal optical axis changing element 52 instead of the mirror 5 of the fifth embodiment. This liquid crystal optical axis changing element 52 selectively switches its state between a reflecting state and a transmitting state by changing a voltage applied thereto. By this switch between reflection and transmission, the incidence of a light beam 30 on an objective lens 31 or on a mirror 6 is switched to make the recording or reproduction of four types of optical discs compatible.

Although examples of compatibility using the two objective lenses for four types of optical discs having different specifications are given in the above respective embodiments, similar effects can be obtained by a similar construction also in compatibility using three or more objective lenses if the objective lenses are arranged in a propagation direction of a light beam.

As described above, an optical head device according to one aspect of the present invention comprises a light source for emitting a plurality of lights having different wavelengths; focusing means for focusing a light spot on an information recording medium with a track; and detecting means for detecting a light reflected from the information recording medium, wherein the focusing means includes a first objective lens for focusing a light spot on a first information recording medium, a second objective lens for focusing a light spot on a second information recording medium different from the first information recording medium, and optical axis changing means for splitting one of the plurality of lights from the light source into a transmitting light and a reflected light at a specified ratio, introducing the reflected light to the first objective lens and the transmitting light to the second objective lens, and introducing the remainder of the plurality of lights from the light source to either one of the first and second objective lenses.

In this optical head device, the one light out of the plurality of lights from the light source is split into the transmitting light and the reflected light at the specified ratio, and the reflected light of the one light is introduced to the first objective lens and the transmitting light thereof is introduced to the second objective lens. Thus, information can be recorded in or reproduced from the first information recording medium suitable for the first objective lens and the wavelength of the one light, and information can be recorded in or reproduced from the second information recording medium suitable for the second objective lens and the wavelength of the one light. Further, since the remainder of the plurality of lights from the light source is introduced to either one of the first and second objective lenses, information can be recorded in or reproduced from a third information recording medium suitable for this objective lens and the wavelength of the remaining light. Furthermore, an optical system from the light source to the optical axis changing means and from the optical axis changing means to the detecting means can be commonly used for the above first to third information recording media, the number of parts constituting the optical system can be reduced. As a result, it is possible to record or reproduce information in a plurality of information recording media having different specifications and miniaturization and lower costs can be realized by reducing the number of parts.

It is preferable that the light source emits first to third lights having different wavelengths; that the optical axis changing means includes a first surface for reflecting and transmitting the first light at a specified ratio to split it into a first transmitting light and a first reflected light and introducing the first reflected light to the first objective lens, and a second surface for reflecting the first transmitting light and introducing it to the second objective lens; that the first surface transmits the second or third light and introduces a second transmitting light to the second surface; and that the second surface reflects the second transmitting light and introduces a second reflected light to the second objective lens.

In this case, the first light is reflected and transmitted at the specified ratio by the first surface to be split into the first transmitting light and the first reflected light, and the first reflected light is introduced to the first objective lens. The first transmitting light is reflected by the second surface and introduced to the second objective lens. Thus, information can be recorded in or reproduced from the first information recording medium suitable for the first objective lens and the wavelength of the first light, and information can be recorded in or reproduced from the second information recording medium suitable for the second objective lens and the wavelength of the first light. Further, the second or third light is transmitted by the first surface and the second transmitting light is introduced to the second surface, which reflects the second transmitting light and introduces the second reflected light to the second objective lens. Thus, information can be recorded in or reproduced from the third information recording medium suitable for the second objective lens and the wavelength of the second light, and information can be recorded in or reproduced from the fourth information recording medium suitable for the second objective lens and the wavelength of the third light. Further, since the optical system from the light source to the optical axis changing means and from the optical axis changing means to the detecting means can be commonly used for the above first to fourth information recording media, the number of parts constituting the optical system can be reduced.

The light source may emit first to third lights having different wavelengths; the optical axis changing means may include a first surface for reflecting and transmitting the first light at a specified ratio to split it into a first transmitting light and a first reflected light and introducing the first reflected light to the first objective lens, and a second surface for reflecting the first transmitting light and introducing it to the second objective lens; and the first surface may reflect the second or third light and introduce a second reflected light to the first objective lens.

In this case, the first light is reflected and transmitted at the specified ratio by the first surface to be split into the first transmitting light and the first reflected light, and the first reflected light is introduced to the first objective lens. The first transmitting light is reflected by the second surface to be introduced to the second objective lens. Thus, information can be recorded in or reproduced from the first information recording medium suitable for the first objective lens and the wavelength of the first light, and information can be recorded in or reproduced from the second information recording medium suitable for the second objective lens and the wavelength of the first light. Further, since the second or third light is reflected by the first surface and the second reflected light is introduced to the first objective lens, information can be recorded in or reproduced from the third information recording medium suitable for the first objective lens and the wavelength of the second light, and information can be recorded in or reproduced from the fourth information recording medium suitable for the first objective lens and the wavelength of the third light. Further, since the optical system from the light source to the optical axis changing means and from the optical axis changing means to the detecting means can be commonly used for the above first to fourth information recording media, the number of parts constituting the optical system can be reduced.

The wavelength of the first light is preferably about 405 nm. In this case, information can be recorded in or reproduced from high-density information recording media having different specifications such as BDs and HD-DVDs utilizing lights having a wavelength of 405 nm.

It is preferable that the first surface reflects 70% to 90% of the first light and introduces it to the first objective lens while transmitting the remaining light; and that the second surface reflects the first light having transmitting through the first surface and introduces it to the second objective lens.

In this case, information can be recorded in high-density information recording media such as BDs and HD-DVDs using the first objective lens to which 70% to 90% of the first light is introduced, and information can be reproduced from other high-density information recording media having different specifications using the second objective lens to which the remaining light is introduced.

It is preferable that the first surface reflects 10% to 30% of the first light and introduces it to the first objective lens while transmitting the remaining light; and that the second surface reflects the first light having transmitting through the first surface and introduces it to the second objective lens.

In this case, information can be reproduced from high-density information recording media such as BDs and HD-DVDs using the first objective lens to which 10% to 30% of the first light is introduced, and information can be recorded in other high-density information recording media having different specifications using the second objective lens to which the remaining light is introduced.

It is preferable that the first surface reflects about 50% of the first light and introduces it to the first objective lens while transmitting the remaining light; and that the second surface reflects the first light having transmitting through the first surface and introduces it to the second objective lens.

In this case, information can be reproduced from high-density information recording media such as BDs and HD-DVDs using the first objective lens to which about 50 of the first light is introduced, and information can be recorded in other high-density information recording media having different specifications using the second objective lens to which the remaining light is introduced.

The NA of one of the first and second objective lenses is preferably 0.85 or larger and that of the other is preferably about 0.65.

In this case, information can be recorded in or reproduced from BDs using the objective lens having an NA of 0.85 or larger, and information can be recorded in or reproduced from HD-DVDS, DVDs and CDs using the objective lens having an NA of about 0.65 or larger.

The focal length of one of the first and second objective lenses having a smaller NA is preferably longer that of the other of the first and second objective lenses having a larger NA.

In this case, since the focusing positions of light spots by the first and second objective lenses differ from each other in the thickness direction of the information recording media, adverse effects of light from the objective lens having the smaller NA can be prevented when recording or reproduction is performed for a BD using the objective lens having the larger NA, and adverse effects of light from the objective lens having the larger NA can be prevented when recording or reproduction is performed for a HD-DVD using the objective lens having the smaller NA.

It is preferable that the NA of one of the first and second objective lenses is about 0.85 or larger and that of the other is about 0.65; and that the first and second objective lenses satisfy a relationship: f2≈(f1×0.85)/0.65 if f1, f2 denote the focal length of one of the first and second objective lenses having a larger NA and the focal length of the other of the first and second objective lenses having a smaller NA.

In this case, the diameter of a beam of light reflected by a BD and having transmitted through the objective lens having the larger NA is substantially equal to that of a beam of light reflected by a HD-DVD and having transmitted through the objective lens having the smaller NA and, in the detecting means, the shape of a detection spot by the reflected light from the BD and that of a detection spot by the reflected light from the HD-DVD are substantially equal. Therefore, the reflected lights from the BD and HD-DVD can be detected using one detecting means.

The light source preferably includes a first light source for emitting a first light having a first wavelength, and a second light source for emitting second and third lights having second and third wavelengths longer than the first wavelength.

In this case, low-cost semiconductor lasers can be used as the first and second light sources, enabling further cost reduction.

The detecting means preferably includes first detecting means for detecting a reflected light of the first light from the information recording medium and second detecting means for detecting a reflected light of the second or third light from the information recording medium.

In this case, low-cost photodetectors can be used as the first and second detecting means, enabling further cost reduction.

The light source and detecting means preferably include a first unit as an integral unit of a first light source for emitting a first light having a first wavelength and first detecting means for detecting a reflected light of the first light from the information recording medium, and a second unit as an integral unit of a second light source for emitting second and third lights having second and third wavelengths longer than the first wavelength and second detecting means for detecting a reflected light of the second or third light from the information recording medium.

In this case, the costs of the first and second units can be reduced since the light sources and photodetectors suitable for the respective wavelengths are unitized.

An optical information device according to another aspect of the present invention comprises any one of the above optical head devices for recording and/or reproducing information in and/or from an information recording medium using the optical head device.

In this optical information device, the optical head device can record or reproduce information in or from a plurality of information recording media having different specifications, and miniaturization and cost reduction can be realized by decreasing the number of parts. Therefore, the miniaturization and cost reduction of the optical information device capable of recording or reproducing information in or from a plurality of information recording media having different specifications can be realized.

An optical head device according to another aspect of the present invention comprises a light source for emitting a plurality of lights having different wavelengths; focusing means for focusing a light spot on an information recording medium with a track; and detecting means for detecting a light reflected from the information recording medium, wherein the focusing means includes a plurality of objective lenses for focusing light spots on a plurality of different information recording media and a plurality of optical axis changing means on which beams of light from the light source are incident in the same direction and which introduce the beams of light to the objective lenses, the plurality of objective lenses are arranged in a propagation direction of beams of light from the light source, and one of the plurality of optical axis changing means closer to the light source is moved to introduce the beam of light to the specified one of the plurality of objective lens.

An optical head device according to another aspect of the present invention comprises a light source for emitting three lights having different wavelengths; focusing means for focusing a light spot on an information recording medium with a track; and detecting means for detecting a light reflected from the information recording medium, wherein the focusing means includes first and second objective lenses for focusing light spots on a plurality of different information recording media and first and second optical axis changing means on which beams of light from the light source are incident in the same direction and which introduce the beams of light to the objective lenses, the first and second optical axis changing means introduce the beam of light to the specified one of the two objective lenses by arranging the two objective lenses in a propagation direction of beams of light from the light source and by moving the first optical axis changing means closer to the light source out of the two optical axis changing means.

The first optical axis changing means is preferably moved in a direction perpendicular to the propagation direction of the beams of light from the light source.

An optical head device according to another aspect of the present invention comprises a light source for emitting a plurality of lights having different wavelengths; focusing means for focusing a light spot on an information recording medium with a track; and detecting means for detecting a light reflected from the information recording medium, wherein the focusing means includes a plurality of objective lenses for focusing light spots on a plurality of different information recording media and one optical axis changing means on which beams of light from the light source are incident in the same direction and which introduces the beams of light to the objective lenses, the plurality of objective lenses are arranged in a propagation direction of beams of light from the light source, and the beam of light is introduced to the specified one of the plurality of objective lenses by a movement of the optical axis changing means in the propagation direction of the beams of light.

An optical head device according to another aspect of the present invention comprises a light source for emitting three lights having different wavelengths; focusing means for focusing a light spot on an information recording medium with a track; and detecting means for detecting a light reflected from the information recording medium, wherein the focusing means includes first and second objective lenses for focusing light spots on a plurality of different information recording media and one axis changing means on which beams of light from the light source are incident in the same direction and which introduces the beams of light to the objective lenses, the first and second objective lenses are arranged in a propagation direction of beams of light from the light source, and the beam of light is introduced to the specified one of the plurality of objective lenses by a movement of the optical axis changing means in the propagation direction of the beams of light.

An optical head device according to another aspect of the present invention comprises a light source for emitting three lights having different wavelengths; focusing means for focusing a light spot on an information recording medium with a track; and detecting means for detecting a light reflected from the information recording medium, wherein the focusing means includes first and second objective lenses for focusing light spots on a plurality of different information recording media and two optical axis changing means on which beams of light from the light source are incident in the same direction and which introduce the beams of light to the objective lenses, the first one of the optical axis changing means closer to the light source has a function of selectively switching the transmission and reflection of one or a plurality of beams of light from the plurality of light sources in accordance with the information recording medium to have information recorded therein or reproduced therefrom.

The first optical axis changing means preferably includes a liquid crystal element and has a function of selectively switching the transmission and reflection of one or a plurality of beams of light from the plurality of light sources by a voltage to be applied to the liquid crystal element in accordance with the information recording medium to have information recorded therein or reproduced therefrom.

One of the three wavelengths of the light source is preferably about 405 nm.

The NA of one of the first and second objective lenses is preferably 0.85 or larger, and that of the other is preferably about 0.65.

An optical information device according to another aspect of the present invention comprises any one of the above optical head devices for recording and/or reproducing information in and/or from an information recording medium using the optical head device.

According to the above optical head device and optical information device, recording and reproduction in and from a plurality of optical discs having different specifications can be made compatible, and small-sized and low-cost devices can be realized.

### INDUSTRIAL APPLICABILITY

An optical head device and an optical information device according to the present invention have a function of recording and/or reproducing information in and/or from an information recording medium and are useful as devices for recording and/or reproducing videos and music. They are also applicable to the storage of data and programs of a computer, the storage of map data of car navigation and the like.

1-14. (canceled)

15. An optical head device, comprising:
a light source for emitting a plurality of lights having different wavelengths;
a focusing portion for focusing a light spot on an information recording medium with a track; and
a detecting portion for detecting a light reflected from the information recording medium, wherein the focusing portion includes:
a first objective lens for focusing a light spot on a first information recording medium,
a second objective lens for focusing a light spot on a second information recording medium different from the first information recording medium, and
an optical axis changing portion for splitting one of the plurality of lights from the light source into a transmitting light and a reflected light at a specified ratio, introducing the reflected light to the first objective lens and the transmitting light to the second objective lens, and introducing the remainder of the plurality of lights from the light source to either one of the first and second objective lenses.

16. An optical head device according to claim 15, wherein:
the light source emits first to third lights having different wavelengths;
the optical axis changing portion includes a first surface for reflecting and transmitting the first light at a specified ratio to split it into a first transmitting light and a first reflected light and introducing the first reflected light to the first objective lens, and a second surface for reflecting the first transmitting light and introducing it to the second objective lens;
the first surface transmits the second or third light and introduces a second transmitting light to the second surface; and
the second surface reflects the second transmitting light and introduces a second reflected light to the second objective lens.

17. An optical head device according to claim 15, wherein:
the light source emits first to third lights having different wavelengths;
the optical axis changing portion includes a first surface for reflecting and transmitting the first light at a specified ratio to split it into a first transmitting light and a first reflected light and introducing the first reflected light to the first objective lens, and a second surface for reflecting the first transmitting light and introducing it to the second objective lens; and
the first surface reflects the second or third light and introduces a second reflected light to the first objective lens.

18. An optical head device according to claim 16, wherein the wavelength of the first light is about 405 nm.

19. An optical head device according to claim 18, wherein:
the first surface reflects 70% to 90% of the first light and introduces it to the first objective lens while transmitting the remaining light; and
the second surface reflects the first light having transmitting through the first surface and introduces it to the second objective lens.

20. An optical head device according to claim 18, wherein:
the first surface reflects 10% to 30% of the first light and introduces it to the first objective lens while transmitting the remaining light; and
the second surface reflects the first light having transmitting through the first surface and introduces it to the second objective lens.

21. An optical head device according to claim 18, wherein:
the first surface reflects about 50% of the first light and introduces it to the first objective lens while transmitting the remaining light; and
the second surface reflects the first light having transmitting through the first surface and introduces it to the second objective lens.

22. An optical head device according to claim 15, wherein the NA of one of the first and second objective lenses is 0.85 or larger and that of the other is about 0.65.

23. An optical head device according to claim 22, wherein the focal length of one of the first and second objective lenses having a smaller NA is longer that of the other of the first and second objective lenses having a larger NA.

24. An optical head device according to claim 15, wherein:
the NA of one of the first and second objective lenses is about 0.85 or larger, and that of the other is about 0.65; and
the first and second objective lenses satisfy a relationship: f2≈(f1×0.85)/0.65 if f1, f2 denote the focal length of one of the first and second objective lenses having a larger NA and the focal length of the other of the first and second objective lenses having a smaller NA.

25. An optical head device according to claim 15, wherein the light source includes:
a first light source for emitting a first light having a first wavelength, and
a second light source for emitting second and third lights having second and third wavelengths longer than the first wavelength.

26. An optical head device according to claim 25, wherein the detecting portion includes a first detecting portion for detecting a reflected light of the first light from the information recording medium and a second detecting portion for detecting a reflected light of the second or third light from the information recording medium.

27. An optical head device according to claim 15, wherein the light source and detecting portion include:
a first unit as an integral unit of a first light source for emitting a first light having a first wavelength and a first detecting portion for detecting a reflected light of the first light from the information recording medium, and
a second unit as an integral unit of a second light source for emitting second and third lights having second and third wavelengths longer than the first wavelength and a second detecting portion for detecting a reflected light of the second or third light from the information recording medium.

28. An optical information device, comprising an optical head device according to claim 15 for recording and/or reproducing information in and/or from an information recording medium using the optical head device.
